(19) United States
(12) Patent Application Publication
(10) Pub. No.: US 2021/0270330 A1
(43) Pub. Date: Sep. 2, 2021

(54) MULTIPLE DISC CLUTCH DEVICE

(71) Applicant: NSK-WARNER K.K., Tokyo (JP)

(72) Inventor: Takafumi HAGITA, Fukuroi-shi (JP)

(21) Appl. No.: 17/176,174

(22) Filed: Feb. 15, 2021

(30) Foreign Application Priority Data
Feb. 27, 2020 (JP) 2020-031611

(51) Int. Cl. F16D 25/08; F16D 43/08

(52) U.S. Cl. CPC F16D 25/083; F16D 43/08

(57) ABSTRACT

A multiple disc clutch device has a piston in which the surrounding structure and operation control are simplified. The multiple disc clutch device includes a cam mechanism part that axially moves the piston. The cam mechanism part includes an annular cam member B and an annular cam member A. The cam member B is disposed coaxially with the piston and is axially movable. The cam member A axially faces the cam member B and is rotatable relative to the cam member B. The cam mechanism part converts rotation of the cam member A into axial movement of the cam member B to axially move the piston by the axial movement of the cam member B.

The disclosure of the following priority application is herein incorporated by reference:

Japanese Patent Application No. 2020-031611 filed on Feb. 27, 2020.

### BACKGROUND OF THE INVENTION

### Technical Field

The present invention relates to a multiple disc clutch device that is incorporated into an automatic transmission of an automobile or the like.

### Background Art

Multiple disc clutch devices are widely used in automatic transmissions of automobiles and the like, as a mechanism for transmitting a driving force. Such a multiple disc clutch device includes, for example, a wet type multiple disc clutch. The wet type multiple disc clutch includes multiple friction plates and multiple separator plates that are alternately disposed in an axial direction. The friction plate has a wet type friction material adhering on its surface. The separator plate functions as a friction mating material. These friction plates and separator plates are mutually pressed to be engaged with each other or are disengaged from each other by a piston that moves in the axial direction due to oil pressure, whereby transmission and non-transmission of a driving force are switched (refer to JP-A-2006-207665, for example).

### PRIOR ART REFERENCE

### Patent Document

Patent Document 1: Japanese Patent Application Laid Open No. 2006-207665

### SUMMARY OF THE INVENTION

### Technical Problem

The wet type multiple disc clutch disclosed in JP-A-2006-207665 needs to be provided with an oil pressure chamber that is supplied with operating oil for moving the piston. Moreover, due to controlling the movement of the piston by oil pressure, a minute oil pressure circuit is necessary for the complicated control. For this reason, the oil pressure circuit structure may not sufficiently cope with more minute and complicated control.

The present invention has been made in view of these circumstances, and a subject of the present invention is to provide a multiple disc clutch device having a piston in which the surrounding structure and operation control are simplified.

### Solution to Problem

To solve the above problems, a multiple disc clutch device according to the present invention includes multiple friction plates, multiple separator plates, an annular piston, and a driving part. The friction plates are axially provided to one of an inner cylinder member and an outer cylinder member. The multiple separator plates are provided to the other of the inner cylinder member and the outer cylinder member and are disposed alternately in the axial direction with the multiple friction plates. The piston is configured to move in the axial direction to switch between engagement and disengagement of the multiple friction plates and the multiple separator plates. The driving part is configured to move the piston in the axial direction. The driving part includes a cam mechanism that includes an annular movable member and an annular rotatable member. The movable member is disposed coaxially with the piston and is axially movable. The rotatable member is disposed so as to axially face the movable member and is rotatable relative to the movable member. The cam mechanism is configured to convert rotation of the rotatable member into axial movement of the movable member to move the piston in the axial direction by the axial movement of the movable member.

The present invention provides a multiple disc clutch device having a piston in which the surrounding structure and operation control are simplified.

### BRIEF DESCRIPTION OF THE DRAWINGS

FIG. 1A is a side view illustrating a multiple disc clutch device according to an embodiment as seen from a radially outer side and illustrates a disengaged state of the multiple disc clutch device; FIG. 1B is an arrow view as seen from an arrow 1b in FIGS. 1A and 1s a front view as seen from one side in an axial direction; FIG. 1C is an arrow sectional view along a line 1c-1c in FIG. 1B;

FIG. 2A is a side view illustrating the multiple disc clutch device according to the embodiment as seen from the radially outer side and illustrates an engaged state of the multiple disc clutch device; FIG. 2B is an arrow view as seen from an arrow 2b in FIG. 2A and is a front view as seen from the one side in the axial direction; FIG. 2C is an arrow sectional view along a line 2c-2c in FIG. 2B; and

FIG. 3 is an exploded view illustrating the structure of the multiple disc clutch device according to the embodiment.

### DESCRIPTION OF THE PREFERRED EMBODIMENTS

Hereinafter, a multiple disc clutch device according to an embodiment of the present invention will be described with reference to the drawings. Note that the multiple disc clutch device according to this embodiment is a wet type multiple disc clutch.

First, directions relating to the multiple disc clutch device according to this embodiment will be defined. In this embodiment, a “center axis C” means a center axis C of the multiple disc clutch device, and an “axial direction”, a “radial direction”, and a “circumferential direction” mean an axial direction, a radial direction, and a circumferential direction with respect to the center axis C, respectively.

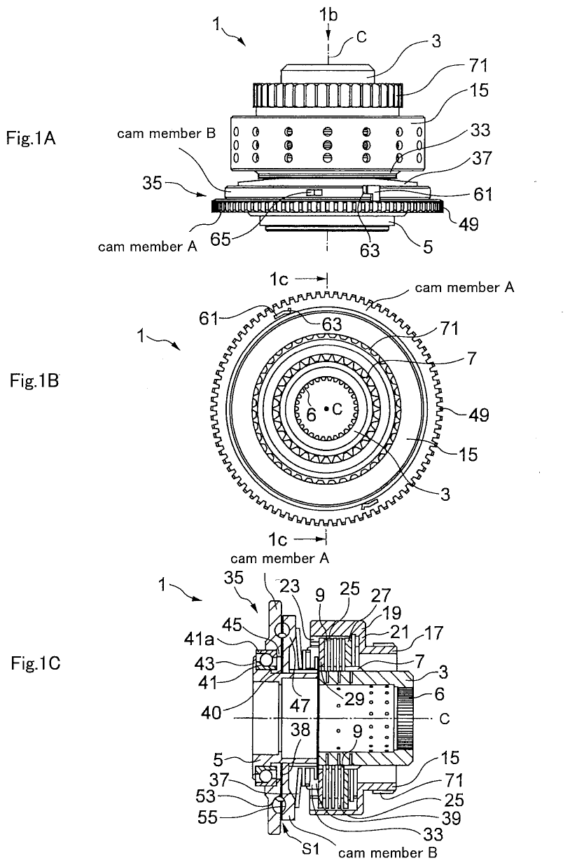

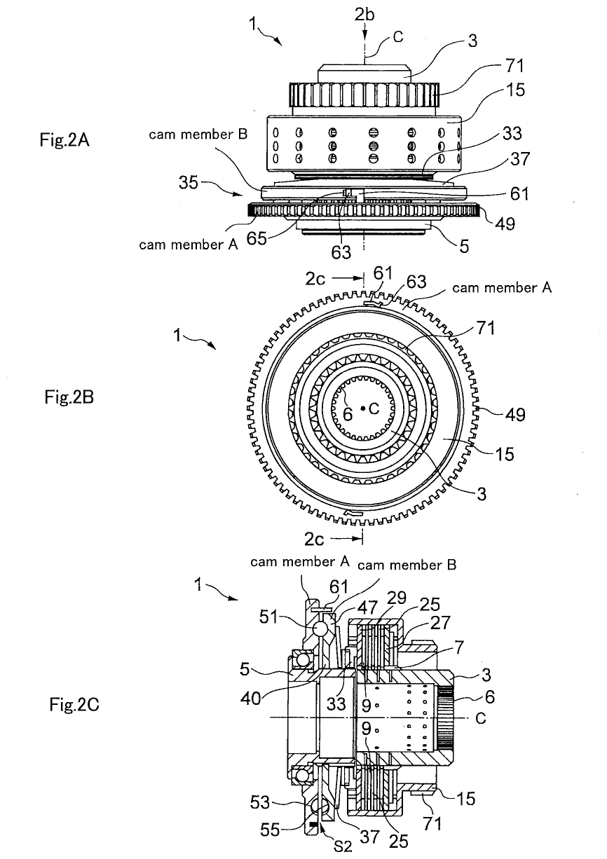

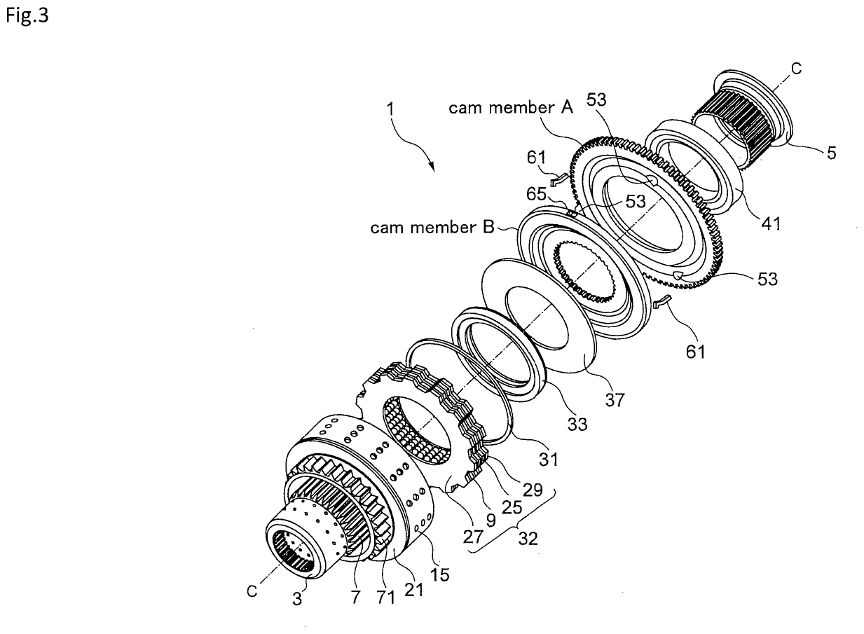

As for the axial direction, in FIGS. 1A and 2A, the upper side of the paper surface is one side in the axial direction, whereas the lower side of the paper surface is the other side in the axial direction. In FIGS. 1B and 2B, the front side of the paper surface is one side in the axial direction, whereas the depth side of the paper surface is the other side in the axial direction. In FIGS. 1C and 2C, the right side of the paper surface is one side in the axial direction, whereas the left side of the paper surface is the other side in the axial direction. In FIG. 3, the lower left side of the paper surface is one side in the axial direction, whereas the upper right side of the paper surface is the other side in the axial direction.

As for the circumferential direction, in FIGS. 1B and 2B, a direction of rotation to the right of the paper surface is one circumferential side or a clockwise direction, whereas a direction of rotation to the left of the paper surface is the other circumferential side or a counterclockwise direction.

FIG. 1A is a side view illustrating the multiple disc clutch device according to the embodiment as seen from a radially outer side and illustrates a disengaged state of the multiple disc clutch device. FIG. 1B is an arrow view as seen from an arrow 1b in FIG. 1A and is a front view as seen from the one side in the axial direction. FIG. 1C is an arrow sectional view along a line 1c-1c in FIG. 1B and illustrates a cross section along the axial direction.

FIG. 2A is a side view illustrating the multiple disc clutch device according to the embodiment as seen from the radially outer side and illustrates an engaged state of the multiple disc clutch device. FIG. 2B is an arrow view as seen from an arrow 2b in FIG. 2A and is a front view as seen from the one side in the axial direction. FIG. 2C is an arrow sectional view along a line 2c-2c in FIG. 2B and illustrates a cross section along the axial direction.

FIG. 3 is an exploded view illustrating the structure of the multiple disc clutch device according to the embodiment.

A multiple disc clutch device 1 according to this embodiment includes a cylindrical shaft 3 and a cylindrical hub 5. The shaft 3 is configured to be fitted onto an input shaft (not shown) to which a driving force is transmitted from an engine (not shown). The hub 5 is configured to be fitted onto the input shaft, in adjacent to the other side in the axial direction of the shaft 3. The input shaft fits into the teeth part 6 that is provided on an inner circumferential surface of the shaft 3 at an end on the one side in the axial direction thereof. The shaft 3 is disposed on the center axis C and rotates integrally with the input shaft. The hub 5 supports a ball bearing 41, cam members A and B, a return spring 37, and a piston 33, as described later. The hub 5 is disposed on the center axis C coaxially with the shaft 3, and the hub 5 is only supported by the input shaft and does not rotate integrally with nor corotate with the input shaft.

A spline 7 is provided at a part of an outer circumferential surface of the shaft 3 on the other side in the axial direction thereof. Multiple annular friction plates 9 are axially movably fitted onto the spline 7. In this embodiment, there are four friction plates 9. The friction plate 9 is formed by attaching a wet type friction material (not shown) on a surface of an annular core plate (not shown) as a metal base plate.

A cylindrical housing 15 is disposed on a radially outside of the shaft 3 via a predetermined space in a manner coaxially and relatively rotatable with the shaft 3. The housing 15 is composed of a small diameter part 17 on the one side in the axial direction and a large diameter part 19 on the other side in the axial direction. The small diameter part 17 and the large diameter part 19 are formed into one body via a step 21. The large diameter part 19 of the housing 15 radially faces the spline 7 formed on the outer circumferential surface of the shaft 3.

A spline 23 is provided on an inner circumferential surface of the large diameter part 19 of the housing 15. Multiple annular separator plates 25 are axially movably fitted to the spline 23. In this embodiment, there are three separator plates 25. Each separator plate 25 is formed of one metal plate. These separator plates 25 are respectively disposed between axially adjacent friction plates 9. That is, the friction plates 9 and the separator plates 25 are alternately disposed in the axial direction.

The housing 15 also is provided with an annular backing plate 27 and an annular selection plate 29. The backing plate 27 holds the friction plates 9 and the separator plates 25 in a secured state at one end of the housing 15 on the one side in the axial direction. The selection plate 29 is disposed on the other side in the axial direction of the friction plate 9 located at the outermost position on the other side in the axial direction. The selection plate 29 is a plate having a predetermined thickness for reducing variations in clearances between the friction plates 9 and the separator plates 25. As in the case of the separator plates 25, the selection plate 29 is axially movably fitted to the spline 23 on the inner circumferential surface of the housing 15.

A retaining ring 31 (refer to FIG. 3) is fixedly fitted in a part of the inner circumferential surface of the housing 15, adjacent to the other side in the axial direction of the selection plate 29. The retaining ring 31 prevents the selection plate 29, the friction plates 9, and the separator plates 25 from coming off to the other side in the axial direction from the housing 15. Note that the retaining ring 31 is omitted in each of FIGS. 1A to 2C. The selection plate 29, the multiple friction plates 9 and the multiple separator plates 25 which are alternately disposed in the axial direction, and the backing plate 27 constitute a multiple disc clutch part 32.

The multiple disc clutch device 1 also includes a piston 33, a cam mechanism part 35, and a return spring 37. The piston 33 is configured to switch an engaged state and a disengaged state of the multiple disc clutch device 1 by engaging or disengaging the multiple disc clutch part 32, that is, by pressing the multiple friction plates 9 and the multiple separator plates 25 to mutually engage them or mutually disengaging them. The cam mechanism part 35 is configured to drive the piston 33 in the axial direction. The return spring 37 is interposed between the piston 33 and the cam mechanism part 35. The piston 33, the cam mechanism part 35, and the return spring 37 are supported on the outer diameter side of the hub 5. The multiple disc clutch device 1 operates as follows: a driving force that is input from the input shaft (not shown) to the shaft 3 is transmitted to the housing 15 via the multiple disc clutch part 32 in response to engagement of the multiple disc clutch part 32, and the transmission of the driving force from the shaft 3 to the housing 15 is blocked in response to disengagement of the multiple disc clutch part 32.

The piston 33 is an annular member and is disposed at an end on the one side in the axial direction of the hub 5. As illustrated in FIG. 1C, the piston 33 is formed at a part on the outer diameter side of a surface thereof with a protrusion 39 that protrudes to the one side in the axial direction. The protrusion 39 is formed across the entire circumference of the piston 33 in the circumferential direction. A surface on the one side in the axial direction of the protrusion 39 axially faces a surface on the other side in the axial direction of the plate that is disposed at the outermost position on the other side in the axial direction of the multiple disc clutch part 32, that is, a surface on the other side in the axial direction of the selection plate 29, via a slight space for allowing the disengaged state of the multiple disc clutch part 32. An outer diameter side edge of the protrusion 39, that is, an outer diameter side edge of the piston 33, is at a radial direction position corresponding to a middle part between an outer diameter side edge and an inner diameter side edge of the selection plate 29. An inner diameter side edge of the piston 33 axially slidably engages with an outer circumferential part of an end of the hub 5 on the one side in the axial direction thereof.

The cam mechanism part 35 includes an annular cam member A and an annular cam member B. The cam member A is disposed in proximity to an end of the hub 5 on the other side in the axial direction thereof. The cam member B is disposed adjacent to the cam member A on the one side in the axial direction thereof. A surface 38 of the cam member A on the one side in the axial direction thereof and a surface 40 of the cam member B on the other side in the axial direction thereof axially face each other.

A ball bearing 41 is fitted onto an outer circumferential surface of the hub 5 at an end thereof on the other side in the axial direction. The end of the hub 5 on the other side in the axial direction thereof is formed with an outward flange 43. An end of the ball bearing 41 on the other side in the axial direction thereof is in contact with a surface of the outward flange 43 on the one side in the axial direction thereof. This structure restricts the ball bearing 41 from moving to the other side in the axial direction relative to the hub 5. The cam member A is fixedly fitted onto an outer ring 41a of the ball bearing 41. The cam member A is formed with an inward flange 45 on an inner circumferential surface at an end on the one side in the axial direction. The inward flange 45 is in contact with an end surface of the outer ring 41a of the ball bearing 41 on the one side in the axial direction thereof. This structure restricts the cam member A from moving to the other side in the axial direction. [ 0022]

With this structure, the cam member A is rotatable relatively to the hub 5 via the ball bearing 41 while being supported by the hub 5, in the condition of being restricted from moving to the other side in the axial direction. In this embodiment, the cam member A is supported by a member or structure (not shown) so as not to corotate with the input shaft or the shaft 3 when the shaft 3 integrally rotates with the input shaft (not shown). That is, the cam member A is provided so as not to corotate with the input shaft or the shaft 3.

The cam member B has an outer diameter smaller than that of the cam member A. The cam member B is formed with a protrusion 47 at a part of a surface thereof on the outer diameter side and on the one side in the axial direction. The protrusion 47 protrudes to the one side in the axial direction. The protrusion 47 is formed across the entire circumference in the circumferential direction. An inner diameter side edge of the cam member B axially slidably engages with the outer circumferential part of the hub 5. As in the case of the cam member A, the cam member B is supported by a member or structure (not shown) so as not to corotate with the input shaft or the shaft 3 when the shaft 3 integrally rotates with the input shaft. That is, the cam member B is provided so as not to corotate with the input shaft or the shaft 3. Similarly, each of the piston 33 and the return spring 37 is also supported by a member or structure (not shown) so as not to corotate with the input shaft or the shaft 3 when the shaft 3 integrally rotates with the input shaft.

A teeth part 49 is formed across the entire circumference at an outer circumferential part of the cam member A. The teeth part 49 is coupled to a driving device (not shown) via a gear mechanism (not shown). The driving device (not shown) is, for example, an actuator. The cam member A rotates relative to the cam member B by a predetermined angle around the center axis C, in response to input of a driving force from the driving device (not shown) to the teeth part 49. Specifically, the cam member A rotates by a predetermined angle around the center axis C, whereby the position relative to the cam member B is switched between a first rotation position and a second rotation position, as described later.

Multiple balls 51 are interposed at circumferentially equal intervals between the cam members A and B. In this embodiment, there are three balls 51 interposed at circumferentially equal intervals. As illustrated in FIG. 3, three recesses 53 are formed, at circumferentially equal intervals, on the surface 38 of the cam member A. The three recesses 53 are recessed to the other side in the axial direction. The recess 53 is formed into a groove shape which is concaved hemispherically or whose cross section along the axial direction is semicircular or U shaped. The ball 51 is rotatably held in each of the three recesses 53, as illustrated in FIG. 2C. In more detail, the ball 51 is held in the recess 53 in a condition in which a part of half or more of the ball 51 on the other side in the axial direction is contained in the recess 53, whereas the rest part of the ball 51 on the one side in the axial direction protrudes from the recess 53 to the one side in the axial direction.

A recess 55 is formed on the surface 40 of the cam member B on the other side in the axial direction, corresponding to each of the recesses 53 of the cam member A. The recess 55 is recessed to the one side in the axial direction. Thus, three recesses 55 that are recessed to the one side in the axial direction are formed at circumferentially equal intervals on the surface 40 of the cam member B on the other side in the axial direction. The recess 55 is formed into a groove shape having a predetermined length in the circumferential direction. The recess 55 is formed in such a manner as to be deepest at an end on the one circumferential side and be shallowest at an end on the other circumferential side. In more detail, the recess 55 is composed of a deepest part having the deepest depth at an end on the one circumferential side, a shallowest part having the shallowest depth at an end on the other circumferential side, and a middle part having a middle depth between the depth of the deepest part and the depth of the shallowest part, at a part between the deepest part and the shallowest part. The bottom of the deepest part and the bottom of the middle part continue to each other smoothly. The bottom of the middle part and the bottom of the shallowest part continue to each other smoothly. The cam members A and B and the balls 51 constitute the cam mechanism part 35.

The cam mechanism part 35 can take one of two states depending on the rotation position of the cam member A relative to the cam member B. The cam mechanism part 35 takes a first state when the cam member A is at the first rotation position relative to the cam member B, which is the state illustrated in each of FIGS. 1A to 1C. In more detail, the cam mechanism part 35 takes a state in which the recess 53 of the cam member A and the deepest part of the recess 55 of the cam member B axially face each other. In this state, the part of the ball 51 on the one side in the axial direction protruding from the recess 53, which is held in the recess 53 of the cam member A, is contained in the deepest part of the corresponding recess 55 of the cam member B. That is, in this state, the ball 51 is axially held by the bottom of the recess 53 of the cam member A and the bottom of the deepest part of the recess 55 of the cam member B. In this state, the surface 38 of the cam member A on the one side in the axial direction and the surface 40 of the cam member B on the other side in the axial direction axially face each other via a slight space S1.

The cam mechanism part 35 takes a second state when the cam member A rotates relative to the cam member B by a predetermined angle from the first state and is at the second rotation position relative to the cam member B, which is the state illustrated in each of FIGS. 2A to 2C. In more detail, the cam mechanism part 35 takes a state in which the recess 53 of the cam member A axially faces the shallowest part of the corresponding recess 55 of the cam member B. In this state, the part of the ball 51 on the one side in the axial direction protruding from the recess 53, which is held in the recess 53 of the cam member A, is contained in the shallowest part of the recess 55 of the cam member B. That is, in this state, the ball 51 is axially held by the bottom of the recess 53 of the cam member A and the bottom of the shallowest part of the recess 55 of the cam member B. In this state, the cam member B is at a position closer to the one side in the axial direction than in the first state, and the surface 38 on the one side in the axial direction of the cam member A and the surface 40 on the other side in the axial direction of the cam member B axially face each other via a space S2. The axial distance of the space S2 is greater than the axial distance of the space S1 in the first state.

The cam member A rotates relative to the cam member B from the first rotation position to the second rotation position while holding the ball 51 in the recess 53. That is, the ball 51 is continuously held in the recess 53 of the cam member A. In accordance with rotation from the first rotation position to the second rotation position of the cam member A, the part of the ball 51 on the one side in the axial direction protruding from the recess 53 of the cam member A moves from the deepest part to the shallowest part via the middle part of the recess 55 of the cam member B by rolling or sliding. At this time, in accordance with movement of the part of the ball 51 on the one side in the axial direction from the deepest part to the shallowest part of the recess 55 of the cam member B, the cam member B is pressed to the one side in the axial direction by the ball 51 and moves to the one side in the axial direction, on the outer circumferential part of the hub 5. In this manner, the recess 55 of the cam member B constitutes a cam surface that engages with the ball 51 and converts the rotation movement of the cam member A into the straight movement of the cam member B via the ball 51. The depth of the recess 53 of the cam member A and the depth of the recess 55 of the cam member B are appropriately set in order to set the movement of the piston 33 for engaging and disengaging the multiple disc clutch device 1. This movement will be described later.

A lock spring 61 is attached at a radial direction position closer to the outer diameter side than the recess 53, on the surface 38 of the cam member A on the one side in the axial direction. Alternatively, multiple lock springs 61 may be attached on the surface 38 of the cam member A at circumferentially equal intervals. In this embodiment, two lock springs 61 are attached in a manner mutually separated by 180 degrees relative to the center axis C. The lock spring 61 is a plate spring that has a curved surface part 63 protruding radially inward. The lock spring 61 is attached to the cam member A in such a manner as to be slidable on an outer circumferential surface of the cam member B while the curved surface part 63 is pressed onto the outer circumferential surface of the cam member B. That is, the lock spring 61 is in contact with the outer circumferential surface of the cam member B while the curved surface part 63 generates an elastic force in the radially inward direction.

Two recesses 65 are provided on the outer circumferential surface of the cam member B, corresponding to the two lock springs 61 of the cam member A. The two recesses 65 are respectively engageable with the curved surface parts 63 of the two lock springs 61. The recess 65 is a bottomed hole that is radially inwardly recessed from the outer circumferential surface of the cam member B. The lock spring 61 engages with the recess 65 in response to slipping of the curved surface part 63 into the recess 65.

The lock spring 61 of the cam member A and the recess 65 of the cam member B are provided so as not to engage with each other when the cam mechanism part 35 takes the first state, as illustrated in FIG. 1A, and so as to engage with each other when the cam mechanism part 35 takes the second state, as illustrated in FIG. 2A. The lock spring 61 is in the condition in which the curved surface part 63 generates an elastic force in the radially inward direction. Thus, the engagement of the curved surface part 63 of the lock spring 61 with the recess 65 restricts the cam member A from rotating relative to the cam member B as well as restricts the cam member B from moving in the axial direction. As a result, the axial space between the cam members A and B is kept. Moreover, the engagement of the lock spring 61 with the recess 65 holds the engaging position of the cam member A with the cam member B. In this manner, the lock spring 61 and the recess 65 constitute a lock mechanism for locking the rotation of the cam member A relative to the cam member B as well as restricting the axial movement of the cam member B.

The return spring 37 is interposed between the cam member B and the piston 33. The return spring 37 is an annular coned disc spring. An outer diameter side edge of the return spring 37 is in contact with a surface of the protrusion 47 of the cam member B on the one side in the axial direction. An inner diameter side edge of the return spring 37 is in contact with a surface of the piston 33 on the other side in the axial direction and axially slidably engages with the outer circumferential part of the hub 5. The return spring 37 is elastically deformed upon being applied with a force in a direction for axial contraction and generates an elastic force that acts to the one side and the other side in the axial direction, by elastic restoration.

When the cam mechanism part 35 takes the first state, the return spring 37 is disposed between the cam member B and the piston 33 in a natural state, that is, in a condition of not being elastically deformed. In this state, the return spring 37 does not generate an elastic force that acts in the axial direction and thus does not press the piston 33 to the one side in the axial direction. Thus, in this state, the multiple disc clutch part 32 is not engaged, that is, the multiple friction plates 9 and the multiple separator plates 25 are not mutually engaged. In response to this, the shaft 3 idles relative to the housing 15 and does not transmit torque to the housing 15.

On the other hand, when the cam mechanism part 35 takes the second state, the return spring 37 is elastically deformed by being applied with a force in a direction for axial contraction, as described later. The return spring 37 generates an elastic force due to the elastic deformation to press the piston 33 to the one side in the axial direction. The following describes operation of the multiple disc clutch device 1 of this embodiment, including the state of the multiple disc clutch device 1 when the cam mechanism part 35 takes the second state.

The multiple disc clutch device 1 takes the state illustrated in each of FIGS. 1A to 1C, when the cam mechanism part 35 takes the first state, and the multiple disc clutch device 1 is disengaged in this state. In this state, in the cam mechanism part 35, the cam member A is at the first rotation position, the recess 53 of the cam member A and the deepest part of the recess 55 of the cam member B axially face each other, and the ball 51 is axially held by the bottom of the recess 53 of the cam member A and the bottom of the deepest part of the recess 55 of the cam member B, as described above. Moreover, in this state, the surface 38 of the cam member A on the one side in the axial direction and the surface 40 of the cam member B on the other side in the axial direction axially face each other via the slight space S1, and the lock spring 61 of the cam member A and the recess 65 of the cam member B are disengaged from each other. Furthermore, in this state, the multiple friction plates 9 and the multiple separator plates 25 are not mutually engaged, and torque is not transmitted from the shaft 3 to the housing 15.

In this state, a driving force is input to the teeth part 49 of the cam member A by a driving device (not shown). Then, the cam member A rotates relative to the cam member B to the one circumferential side in FIG. 1B, that is, in the clockwise direction, by a predetermined angle, and the cam member A reaches the second rotation position. At this time, in accordance with the rotation of the cam member A, the part of the ball 51 on the one side in the axial direction protruding from the recess 53 of the cam member A moves from the deepest part to the shallowest part via the middle part of the recess 55 of the cam member B. In accordance with the movement of the part of the ball 51 on the one side in the axial direction from the deepest part to the shallowest part of the recess 55 of the cam member B, the cam member B is pressed to the one side in the axial direction by the ball 51 and moves to the one side in the axial direction on the outer circumferential part of the hub 5. Then, the part of the ball 51 on the one side in the axial direction moves to the shallowest part of the recess 55 of the cam member B, and the ball 51 comes to be axially held by the bottom of the recess 53 of the cam member A and the bottom of the shallowest part of the recess 55 of the cam member B, whereby the cam mechanism part 35 takes the second state. That is, the surface 38 on the one side in the axial direction of the cam member A and the surface 40 on the other side in the axial direction of the cam member B come to axially face each other via the space S2. Moreover, the lock spring 61 of the cam member A and the recess 65 of the cam member B engage with each other, so the rotation of the cam member A relative to the cam member B is locked, and axial movement of the cam member B is restricted. Thus, the space S2 between the cam members A and B is kept.

As for the return spring 37, the outer diameter side edge thereof is pressed to the one side in the axial direction by the cam member B that has moved to the one side in the axial direction due to the cam mechanism part 35 taking the second state. Thus, the return spring 37 is axially held by the cam member B that is in contact with the outer diameter side edge, the piston 33 that is in contact with the inner diameter side edge, and a surrounding support part, and the return spring 37 is applied with a force in a direction for axial contraction. The return spring 37 then moves to the one side in the axial direction while being elastically deformed by the applied force in the direction for axial contraction.

The movement of the return spring 37 to the one side in the axial direction, and the elastic force of the return spring 37 acting to the one side in the axial direction, which is generated due to the elastic deformation in the direction for axial contraction, cause the piston 33 to be pressed to the one side in the axial direction by the inner diameter side edge of the return spring 37. The piston 33 that is pressed to the one side in the axial direction presses the multiple disc clutch part 32, that is, the multiple friction plates 9 and the multiple separator plates 25, to the one side in the axial direction, via the selection plate 29. Thus, the piston 33 mutually engages the multiple friction plates 9 and the multiple separator plates 25. That is, the multiple friction plates 9 and the multiple separator plates 25 are friction engaged with each other and rotate integrally. In this state, the multiple disc clutch device 1 takes the engaged state, and torque is transmitted from the shaft 3 to the housing 15.

In this state, the lock spring 61 of the cam member A and the recess 65 of the cam member B engage with each other, so the movement of the cam member B in the axial direction is restricted. This maintains the condition in which the cam member B presses the piston 33 to the one side in the axial direction via the return spring 37. Thus, the engaged state of the multiple disc clutch device 1 is reliably maintained. The lock springs 61 of the cam member A and the recesses 65 of the cam member B engage with each other at positions equally separated in the circumferential direction on the outer circumferential surface of the cam member B. Thus, the cam member B presses the piston 33 to the one side in the axial direction via the return spring 37, with forces that are maintained to be equal across the entire circumference in the circumferential direction. As a result, the multiple friction plates 9 and the multiple separator plates 25 are maintained in the condition of being pressed by forces that are equal across the entire circumference in the circumferential direction, whereby the multiple disc clutch device 1 is maintained in the stably engaged state.

In this manner, in the multiple disc clutch device 1 of this embodiment, the cam member B of the cam mechanism part 35 axially moves to move the piston 33 to the one side in the axial direction via the return spring 37, thereby mutually engaging the multiple friction plates 9 and the multiple separator plates 25.

The torque that is transmitted to the housing 15 is then transmitted to the next transmission mechanism via a member (not shown) that meshes with a teeth part 71 formed on an outer circumferential surface of the small diameter part 17 of the housing 15.

The multiple disc clutch device 1 is switched from the engaged state to the disengaged state by rotating the cam member A from the second rotation position to the first rotation position to change the cam mechanism part 35 to the first state. The cam member B is pressed to the other side in the axial direction by the elastic force of the return spring 37 when the cam mechanism part 35 takes the second state. Thus, at the time when the cam mechanism part 35 is changed to the first state, the part of the ball 51 on the one side in the axial direction protruding from the recess 53 of the cam member A moves to the deepest part of the recess 55 of the cam member B, whereby the cam member B moves to the other side in the axial direction. On the other hand, at the time when the return spring 37 has returned to the natural state, the return spring 37 stops generating an elastic force for pressing the piston 33 to the one side in the axial direction, whereby the multiple friction plates 9 and the multiple separator plates 25 are disengaged from each other. As a result, the multiple disc clutch device 1 takes the disengaged state.

In this manner, in the multiple disc clutch device 1 of this embodiment, the cam mechanism part 35 controls the movement of the piston 33 for switching between mutual engagement and disengagement of the multiple friction plates 9 and the multiple separator plates 25. Thus, this embodiment dispenses with providing an oil pressure chamber that is supplied with operating oil for moving the piston 33. Moreover, it is not necessary to provide a minute oil pressure circuit for controlling the piston 33. As a result, it is possible to simplify the structure surrounding the piston 33 and operation control of the piston 33 in the multiple disc clutch device 1 of this embodiment, and therefore, the space for mounting the multiple disc clutch device 1 can be reduced.

Note that the present invention is not limited to the foregoing embodiment and can be modified and altered.

For example, the friction plate 9 may be provided to the housing 15, and the separator plate 25 may be provided to the shaft 3. The numbers of the friction plates 9 and the separator plates 25 can be appropriately set in consideration of torque capacity. Also, the numbers of the balls 51 and the lock springs 61 can be appropriately set in consideration of a factor such as torque capacity, or a diameter of the cam member A or the cam member B. Meanwhile, the shapes and depths of the recess 53 of the cam member A and the recess 55 of the cam member B are appropriately set in order to set the movement of the piston 33 for engaging and disengaging the multiple disc clutch device 1. That is, the movement of the piston 33 for the engagement and the disengagement of the multiple disc clutch device 1 is set depending on the shape or depth of the recess 53 of the cam member A and of the recess 55 of the cam member B. In another case, the recess 65 may be provided on an outer circumferential surface of the cam member A, and a lock spring for engaging with this recess 65 may be provided to the cam member B. In this case, the outer diameter of the cam member B may be made greater than the outer diameter of the cam member A.

### REFERENCE SINGS LIST

1: multiple disc clutch device
3: shaft
5: hub
7: spline
9: friction plate
15: housing
23: spline
25: separator plate
32: multiple disc clutch part
33: piston
35: cam mechanism part
37: return spring
51: ball
53, 55: recess
61: lock spring

1. A multiple disc clutch device comprising: multiple friction plates axially provided to one of an inner cylinder member and an outer cylinder member;
multiple separator plates provided to the other of the inner cylinder member and the outer cylinder member and axially disposed alternately with the multiple friction plates;
an annular piston configured to axially move to switch between engagement and disengagement of the multiple friction plates and the multiple separator plates; and
a driving part configured to axially move the piston,
wherein the driving part includes a cam mechanism that includes an annular movable member and an annular rotatable member, the movable member is disposed coaxially with the piston and is axially movable,
the rotatable member is disposed to axially face the movable member and is rotatable relative to the movable member, and
the cam mechanism is configured to convert rotation of the rotatable member into axial movement of the movable member to axially move the piston by the axial movement of the movable member.

2. The multiple disc clutch device according to claim 1, wherein the driving part includes multiple balls that are interposed between the rotatable member and the movable member at circumferentially equal intervals, and
the driving part is configured to convert rotation of the rotatable member into axial movement of the movable member via the multiple balls.

3. The multiple disc clutch device according to claim 2, wherein multiple first recesses are provided on a surface of the rotatable member facing the movable member,
multiple second recesses that correspond to the respective first recesses are provided on a surface of the movable member facing the rotatable member,
the second recess has a first part with a predetermined depth and a second part with a depth smaller than the depth of the first recess,
the multiple balls are held respectively between the first recesses and the second recesses rotatably,
the rotatable member is able to be switched between a first rotation position and a second rotation position relative to the movable member, the first recess axially faces the first part of the second recess at the first rotation position, and the first recess axially faces the second part of the second recess at the second rotation position.

4. The multiple disc clutch device according to claim 1, wherein an elastic member is interposed between the movable member and the piston.

5. The multiple disc clutch device according to claim 3, wherein the driving part includes a lock mechanism that restricts rotation of the rotatable member relative to the movable member while restricting axial movement of the movable member, at the time when the rotatable member is at the second rotation position.

6. The multiple disc clutch device according to claim 5, wherein the lock mechanism includes a plate spring provided to the rotatable member and a recess provided to the movable member and engageable with the plate spring.

7. The multiple disc clutch device according to claim 5, wherein the lock mechanism includes a plate spring provided to the movable member, and a recess provided to the rotatable member and engageable with the plate spring.

8. The multiple disc clutch device according to claim 6, wherein the lock mechanism is configured such that the plate spring engages with the recess due to the plate spring urging in a radial direction of the rotatable member.

9. The multiple disc clutch device according to claim 5, wherein the lock mechanism is configured to maintain engagement of the multiple friction plates with the multiple separator plates by restricting axial movement of the movable member.

10. The multiple disc clutch device according to claim 7, wherein the lock mechanism is configured such that the plate spring engages with the recess due to the plate spring urging in a radial direction of the rotatable member.
